(19) United States
(12) Patent Application Publication
(10) Pub. No.: US 2021/0199839 A1
(43) Pub. Date: Jul. 1, 2021

(54) DETECTION SYSTEM USING MAGNETORESISTANCE

(71) Applicant: Lifen Solutions LLC, San Francisco, CA (US)

(72) Inventors: Biao ZHANG, Hinsdale, CA (US); XIAO YANG, LOS GATOS, CA (US); YUNLU CAO, San Francisco, CA (US)

(73) Assignee: Lifen Solutions LLC, San Francisco, CA (US)

(21) Appl. No.: 16/732,302

(22) Filed: Dec. 31, 2019

(51) Int. Cl. G01V 3/38; G01V 3/08; G06N 3/08

(52) U.S. Cl. CPC G01V 3/38; G06N 3/08; G01V 3/08

(57) ABSTRACT

A detection system comprises multiple detection nodes connected to a data bus. Each detection node comprises a magnetic sensor, a data processing unit, and a bus adaptor. The magnetic sensor captures time-dependent magnetic signal. The data processing unit extract a signature feature from the magnetic signal. The signature feature is sent to a server through the data bus; and the server makes a decision based upon the signature feature from the detection nodes using an AI deep learning algorithm.

### TECHNICAL FIELD OF THE DISCLOSURE

The technical field of the examples to be disclosed in the following sections is related generally to the art of detection system capable of detecting metallic objects, and more particularly to detection systems applicable to perimeter security capable of detecting metallic objects by using magnetoresistance.

### BACKGROUND OF THE DISCLOSURE

Gun violence exacts tens of thousands of lives each year, and it is on the rise. Current security systems, especially for use in residential areas, rarely provide modules for detecting deadly metallic weapons such as guns or machetes. For example, a commercial security system generally uses cameras (visible light and/or infrared light) and ultrasound sensors for monitoring a residential zone. These systems do not have the ability to detect metallic objects, especially concealed weapons like guns or machetes.

Some systems use coils that are capable of detecting metallic objects. These systems however are often buried in the ground around the desired security perimeter. These coils generally do not provide sufficient sensitivity to detect a weapon like guns from a practical distance. Even though some existing coils can provide enough sensitivity to detect a metallic object like a gun, the signals from the coils are mixed with background noise signals, and are extremely hard to separate from the noise signals.

Therefore, it is desired to have a detection system applicable to perimeter security and capable of detecting deadly metallic weapons in the vicinity of or crossover a security perimeter boundary. It is further desired to monitor or detect malicious activities or policy violations related to deadly metallic weapons in the vicinity of a security perimeter.

### SUMMARY OF THE DISCLOSURE

In view of the foregoing, a detection system is disclosed herein, the detection system comprising: a wire capable of serving as a data bus; a plurality of detection nodes connected to the wire, wherein each detection node comprises: a magnetic sensor capable of detecting a magnetic field and outputting an MR signal; a data processing unit capable of extracting a signature feature signal from the MR signal; and a data bus adaptor capable of delivering the signature feature signal to the data bus; and a server capable of making a decision based upon the signature feature.

In another example, a method of detecting a metallic object, comprising: providing a detection node that comprises: a wire serving as a data-bus; a server connected to the wire; a plurality of detection nodes connected to the wire, each of the detection node comprises: a magnetic sensor; a data processing unit; and a data adaptor; generating by an MR signal by a magnetic sensor, wherein the MR signal corresponds to the metallic object; extracting a signature feature from the MR signal by the data processing unit; transferring the signature feature by the data adaptor to the data bus; and the server making a decision based upon the signature data;

### BRIEF DESCRIPTION OF DRAWINGS

FIG. 1 diagrammatically illustrates an example of a detection unit of this invention, wherein the detection unit comprises a plurality of sensor nodes, each of which is connected to a bus;

FIG. 2a is a diagram showing an exemplary structure of a sensor nodes in FIG. 1;

FIG. 2b is a diagram showing another exemplary structure of a sensor nodes in FIG. 1;

FIG. 3 diagrammatically illustrates another example of a detection unit of this invention, wherein the detection unit comprises a plurality of sensor nodes, each of which is connected to a bus; and wherein the bus is connected to a repeater;

FIG. 4 is a diagram showing an exemplary implementation of the unit in FIG. 3;

FIG. 5 shows an exemplary data structure for use with the detection unit of this invention;

FIG. 6 diagrammatically shoes an exemplary MR structure that can be used in the sensor note of the detection unit in this invention;

FIG. 7 schematically shows an exemplary layout wherein magnetic sensors of the adjacent sensor nodes in a sensor unit have substantially the same sensing orientation;

FIG. 8 is a diagram showing a part of an exemplary perimeter security system built with the detection units of this invention, wherein multiple detection units are interconnected with one of the detection unit being connected to a server at one end;

FIG. 9 diagrammatically illustrates a time varying signal from a sensor node when a personnel carry a gun approaching said sensor node from remote;

FIG. 10 diagrammatically demonstrates yet another example of a detection unit of this invention, wherein the system comprises multiple magnetic sensors and multiple coils for actively generating magnetic fields in the detection areas; and

FIG. 11 is a flow charting showing the steps executed in an exemplary detecting process of the detection unit.

### DETAILED DESCRIPTION OF SELECTED EXAMPLES

Disclosed herein is a detection system using multiple magnetoresistance (hereafter, MR) sensors. The MR sensors detect magnet field associated with a metallic object. The metallic object can be deadly weapons such as guns and machetes or other types of metallic objects, such as unmanned vehicle plate forms such as AGV (Automated Guided Vehicles), robots, drones or the like. The signals from the MR sensors vary with the movements of the object relative to the sensors. In particular, the MR signals vary with time when the metallic object is moved away from or towards the MR sensors. The detection system can be implemented as a perimeter fence to monitor or detect malicious activities or policy violations, especially those associated with deadly metallic weapons such as guns and machetes and the like. The detection system may have multiple detection nodes that are connected to a data bus. Each detection node may comprise a MR sensor and a data processing unit (hereafter, “DPU”). The DPU can be programmed to extract signature features of instant MR signals by using for example wavelet analysis. The signature features can be delivered to a server that makes decisions based upon the signature features by using for example, AI (Artificial Intelligence) deep learning algorithm.

In the following, the invention will be disclosed with referring to selected examples. It will be appreciated by those skilled in the art that the following discussion including the selected examples are for demonstration purpose only, and should not be interpreted into any limitation.

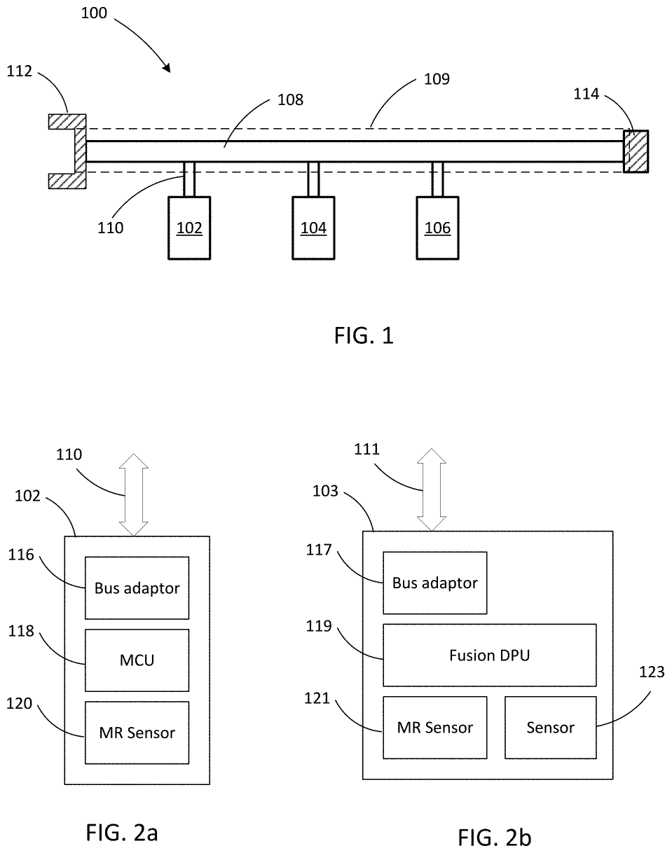

Referring to FIG. 1, an example of a detection unit is illustrated therein. Detection unit 100, which can be a part of a detection system that will be detailed in the following sections, comprises multiple detection nodes, such as detection nodes 102, 104 and 106. Each node is connected to wire 108. Wire 108, which can be a twisted pair, is served as a data bus herein this example. Detection node 102 is connected to data bus 108 through connection 110 that enables data exchange between detection node 102 and data bus 108. As an optional feature, detection unit 100 can comprise adapters to duplicate detection unit 100 and interconnect the duplicated detection unit so as to cover a longer security perimeter. Specifically, female adapter 112 and male adaptor 114 can be provided at the ends of detection unit 108. A detailed example will be discussed in the following with reference to FIG. 8.

Each detection node (e.g. detection nodes 102, 104, and 106) is capable of detecting changes of the local magnetic field over time, wherein the “local magnetic field” is referred to as the magnetic field in the vicinity of the detection node. In some examples, the detection node can be configured to detect the instant (static) local magnetic field. The instant local magnetic fields detected from multiple detection nodes can be used together for the server to make a decision. As an optional feature, each detection node is further capable of extracting signature features of the detected magnetic field signals. This can be accomplished using wavelet analysis algorithms or other suitable data analysis method. It is preferred that the algorithm or other suitable data analysis methods are implemented in the hardware of the detection nodes, for example, in the DPUs of the nodes. A signature feature extracted from a detected magnetic field signal can be of great importance in real applications. This is because on one hand a magnetic field signal often mixed with background noise. It is hard to suppress the noise or eliminate the background noise. On another hand, a time-dependent magnetic field signal is large and compose of many invalid or redundant data. Transferring and processing such data are inefficient and sometimes, becomes inconvenient in applications. Therefore, it is expected to extract the signature features(s) from the magnetic field signal. The signature feature signal carries information that is substantially the same as that embedded in the corresponding magnetic field signal bus has less data.

The signature feature extracted from the detection nodes can be delivered to a server. The server processes the feature signals to generate a decision, for example by using AI (Artificial Intelligent) deep learning algorithm. The decision can be an alert signal or other forms of actions.

Wire 108 serves as data bus in the above example. Depending upon the specific application, wire 108 can be in many other suitable forms, such as co-axial cable or other forms of twisted wires. In one example, wire 108 can be configured into an M-bus.

The detection unit (100) as illustrated in FIG. 1 has three detection nodes. It will be appreciated by those skilled in the art that it is for demonstration purpose. It should not be interpreted as a limitation. The detection unit (100) may comprise any suitable number of detection nodes. The detection nodes of the detection unit can be spaced apart uniformly along the elongated wire 108. In other examples, the detection nodes can be deployed along the wire (108) in any suitable ways according to the specific applications.

The detection node (e.g. 102, 04, and 106) can be implemented in many ways, one of which is illustrated in FIG. 2a. Referring to FIG. 2a, detection mode 102 comprises MR sensor 120, microcontroller unit (MCU) 118, and bus-adaptor 116. Detection node 102 is connected to data bus 108 (in FIG. 1) through connection 110.

MR sensor 120 detects the local magnetic field. Depending upon specific application, MR sensor may comprise 1D (1 dimension), 2D (2 dimension) or 3D (3 dimension) sensing directions. In general, sensing directions of a MR sensor are vertical to each other, e.g. along the X, Y, and Z directions of a Cartesian coordinate. A sensing direction of a MR sensor detects a component of a magnetic field B that is generally a 3D vector.

In one example, the MR sensor 120 captures an instant local magnetic field (e.g. one component or two or three components of the magnetic field). In another example, the MR sensor monitors a local magnetic field over time so as to obtain a time-dependent magnetic field signal. The magnetic field signal from MR sensor 120 is fed into a data processing unit (DPU) that is a MCU (118) in this embodiment. In fact, many other forms of DPU can be used such as a DSP or an ARM (Advanced RISC Machine) unit. MCU 118 receives the magnetic field signal and can extract the signature feature from the magnetic field signal. This feature extraction process can be executed by using a Wavelet Analysis algorithm. There are many different implementations of Wavelet Analysis algorithm in the art, and thus will not be discussed herein. In some examples, the signature features output from MCU 118 can be packaged and delivered to a server for further analysis. This data packaging and delivering can be conducted through bus-adaptor 116, and connection 110 that is connected to the data-bus (108 as illustrated in FIG. 1), the data-bus of which is connected to the server. In instances wherein data bus 108 (FIG. 1) is an M-bus, bus adaptor 116 can be configured into an M-bus adaptor. Because M-bus is known in the art, it will not be discussed herein.

It will be appreciated by those skilled in the art that the above discussion is demonstration purpose. Many other variations are also applicable. For example, data bus 108 can be a FPGA hub. In these examples, the detection nodes are connected to a FPGA hub, which is not illustrated in the figure. The FPGA can be configured to extract signature features from the magnetic field signals. The FPGA hub can be connected to a bus adaptor so as to enabling interconnection to other detection units.

In some examples, different sensors can be incorporated in a detection node, an example of which is illustrated in FIG. 2b. Referring to FIG. 2b, detection node 103 comprises MR sensor 121 and sensor 123. Sensor 123 can be any desired sensors, such as accelerometer, CCD sensor, IR sensor, pressure sensor or many other sensors. Fusion DPU 119 can be provided to perform data fusion for the data from different sensors such as the MR sensor (121) and sensor 123. As an optional feature, fusion DPU 119 can be implemented for extracting signature features of the signals from the MR sensor (121) and/or sensor 123. The fusion DPU can be a MCU, an ARM or other types of units. The fused data from the fusion DPU (119) is prepared for transmission by bus adaptor 117.

Referring back to FIG. 1, it is noted that detection unit 100 can be implemented into a substantially rigid unit or alternatively, it can be implemented into a flexible unit. For example, a rigid tube (109 in FIG. 1) can be provided. Detection nodes 120, 104, and 106 can be anchored to rigid tube 109. The detection nodes can be affixed to rigid tube 109 such that the detection nodes are uniformly spaced along the length of the rigid tube. In instances wherein MR sensors are employed as illustrated in FIG. 2, detection nodes, especially the MR sensors, can be anchored to the rigid tube such that the corresponding sensing directions of the MR sensors are substantially in parallel. Specifically, the sensing directions along the X-direction of the MR sensors can be substantially parallel, and so do the sensing directions along the Y- and Z-direction. This configuration, wherein the sensing directions of the neighboring detection nodes are in parallel and the distance between the neighboring detection nodes are known and fixed, can be of great value to the signal processing. In some examples, detection unit can be implemented into a deformable detection unit. This can be achieved by using deformable tubes or deformable cables or wires, such as twisted wires.

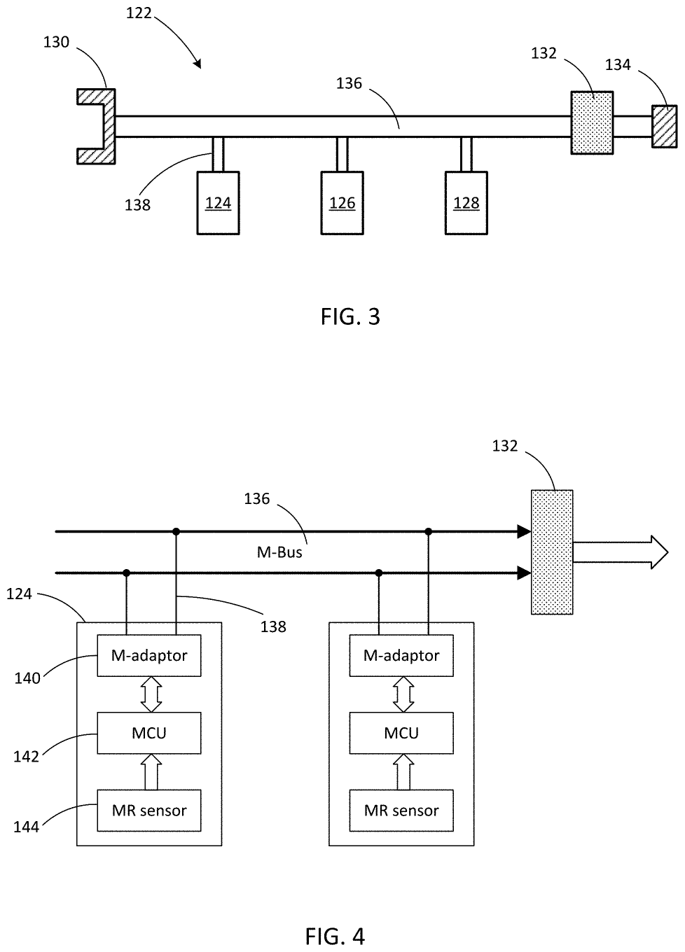

In some examples, multiple detection units are expected to cover a larger area. To facilitate such expectation, the detection unit can be equipped with a repeater, such as a network relay, as illustrated in FIG. 3 and FIG. 4. Referring to FIG. 3 detection unit 122 comprises data-bus 136, to which detection nodes 124, 126 and 128 are connected through connections such as connection 138. Multiple detection units can be interconnected through male adaptor 134 and female adaptor 130. Detection unit 122 can be the same as detection unit 100 discussed above with reference to FIG. 1 and FIG. 2, except repeater 132. In some applications, multiple detection units are interconnected to cover a larger area. Data signal from one detection unit may not be successfully transferred to the server at an end of the long chain of interconnected detection units. This problem can be solved by providing a repeater at a detection unit, such as repeater 132 in detection unity 122 as illustrated in FIG. 3. The repeater can be a network relay or other forms of repeater that is capable of enhancing data transfer along the chain of detection units. The detection unit (122) can be implemented in many ways, one of which is illustrated in FIG. 4.

Referring to FIG. 4, two neighboring detection nodes such as 124 are illustrated for simplicity. In this example, data bus 136 is an M-bus that comprises a twisted wire pair. Repeater 132, which is a network relay is connected to M-bus 136 to enhance the data transfer and connection performance of the detection units. Detection node 124 comprises MR sensor 144, MCU 142, and M-bus adaptor 140. MR sensor 144 detects and captures local magnetic field signal or time-dependent magnetic field signal. MCU 142 processes the magnetic field signal and extracts signature feature(s) of the magnetic signal. The signature feature(s) from the MCU can be processed at M-bus adaptor 140 for delivery to a server through connection 138 and M-bus 136. The data structure used in the M-bus can be in any suitable forms, one of which is illustrated in FIG. 5.

Referring to FIG. 5, data structure 146 comprises 4 (four) segments numbered by #1, #2, #3, and #4. Data segment #1 is the data head with a length of 2 bytes. Data segment #2 is used to identify the length of the data in the instant data package that is to be transferred through the data bus. Data segment #2 has a data length of 2 bytes. Data segment #3 is the data, such as the data associated with the signature feature extracted from the MCU. This segment can be assigned to a length of any suable bytes depending upon specific application. For example, data segment #3 can have a length of 5 bytes, 8 bytes, 10 bytes or 2 bytes. Data segment #4 is assigned as the CRC checksum with a length of 2 bytes.

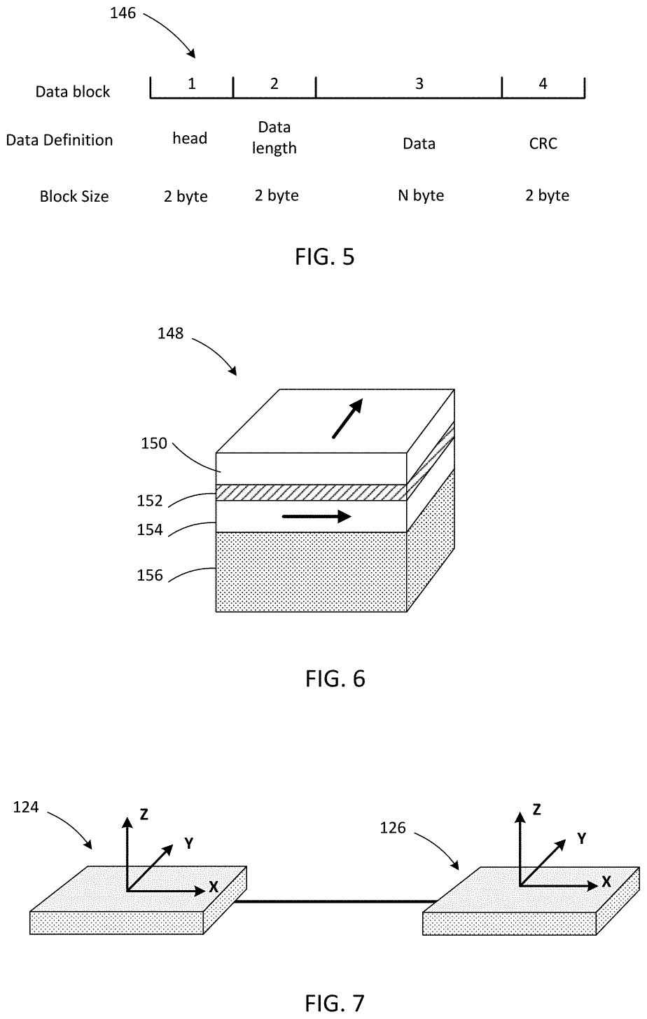

The MR sensor discussed above with reference to FIG. 1 through FIG. 4 can generally be a sensor whose electric resistance changes with the external magnetic field. The MR sensor in the embodiment of this invention can be of any desired forms, such as Hall sensors, AMR (Anisotropic Magnetoresistance) sensors, GMR (Giant magnetoresistance) sensors, or TMR (Tunneling Magnetoresistance) sensors. Other forms of MR sensors can also be used, such as MEMS (micro-electro-mechanical system)-based flux gates or MEMS coils or pickup coils. For demonstration purpose, FIG. 6 shows the basics of a MR structure. It is noted that FIG. 6 is for demonstrating the basic structure of a MR only, other components such as circuits, pads, terminals, and packages are not shown for simplicity.

Referring to FIG. 6, MR structure 148 comprises ferromagnetic layers 150 and 154 and non-magnetic barrier layer 152, wherein barrier layer 152 is laminated between ferromagnetic layers 150 and 154. Ferromagnetic layer 150 has a magnetic orientation that rotates “freely” and aligned substantially according to the external magnetic field. For this reason, ferromagnetic layer 150 is often referred to as “free layer.” Ferromagnetic layer 154 is often referred to as “reference layer” whose magnetic orientation is substantially “fixed” by magnetic layer 156 such that the magnetic orientation of the reference layer does not respond to the external magnetic field in a designed dynamic range.

The barrier layer (152) can be a non-magnetic metallic layer such as copper, in which instance, MR structure 148 is referred to as a Giant Magnetoresistance (GMR). The barrier layer (152) can also be an oxide layer, such as MgO or Al2O3. The MR structure is a Tunneling Magnetoresistance TMR.

In a sensing configuration, the default magnetic orientation of free layer 150 and the default magnetic orientation of reference layer 154 are perpendicular to each other (e.g. when viewed from the top of the two layers), as illustrated in FIG. 6. In the presence of an external magnetic field B, the magnetic orientation of free layer 150 rotates in the plane of free layer 150, approaching a position parallel to or anti-parallel to the orientation of reference layer 154. The resistance (i.e. magnetoresistance) decreases as the magnetic orientation of the free layer rotates towards a state parallel to the magnetic orientation of the reference layer. The magnetic resistance increases as the magnetic orientation of the free layer rotates towards a state antiparallel to the magnetic orientation of the reference layer. The angle between the magnetic orientations of the free layer and reference layer is proportional to the external magnetic field; and the magnetoresistance is proportional to such angle. Therefore, the external magnetic field can be calculated from the magnetoresistance. It can be seen that the magnetoresistance has a default sensing direction, for example, along the magnetic orientation of the reference layer (154) as shown in FIG. 1. A magnetic sensor with such configuration is often referred to as a 1D magnetic sensor. By assembling three 1D magnetic sensors with each magnetic sensor designated for one of the three directions in a typical 3D Cartesian coordinate, a 3D magnetic sensor can be obtained. Sometimes a 3D magnetic sensor is referred to as 3DOF (Degree of Freedom) magnetic sensor or magnetometer. 3D magnetic sensor can be used in examples of this invention as shown in FIG. 7.

Referring to FIG. 7, 3D magnetic sensors 124 and 126 can be used. As discussed in the above sections, detection nodes (e.g. 102, 104, and 106 in FIG. 1) can be deployed such that the sensing directions of the detection nodes are substantially parallel. In the example wherein the detection nodes have 3D magnetic sensors, the sensing directions of sensors e124 and 126 are substantially parallel. Specifically, the sensing directions along the X-direction of sensors 124 and 126 are substantially parallels. The sensing directions along the Y-direction of sensors 124 and 126 are substantially parallels, and the same as the directions along the Y-direction. In some examples, the sensors 124 and 126 are anchored to a rigid tube. The space between the two neighboring sensors 124 and 126 are predetermined. This configuration helps to increase the accuracy and sensitivity of the detection unit.

The detection unit as discussed above can be repeated so as to form a chain of detection unit to cover a wide area or a longer area, as illustrated in FIG. 8. For demonstration purpose, two detection units 12 and 158 are illustrated. Detection unit 122 comprises multiple detection nodes such as note 126. Detection units 122 and 158 are interconnected through male adapter 134 and female adaptor 162. It is noted that the connection adapters are not only for mechanical connection but also for data transfer. Server 160 can be connected as an end of the chain of the detection units, such as an end of detection unit 158. The server is provided for making a decision based upon the data transferred from the detection units, such as the signature features obtained by the detection units. In an embodiment of the invention, the server processes the data based upon an AI deep learning algorithm. The decision made by the server can be in many suitable forms, such as generating an alarm signal or generating a trigger signal to trigger a preset event such as making a noise or lighting an alarm bulb.

The server (160) can be implemented into many suitable ways. For example, multiple servers can be deployed. One server can be designated for accelerating AI algorithm and thus, may compose an AI accelerator, which can be DPU (data processing unit), NPU (Network Processing Unit), or NNU (Network Node Unit). It is preferred that a low-power and high-performance AI accelerator is employed, such as Intel NCS, GTI 2801 and Google Coral. An accompanying server can be a MCU or embedded CPU capable of making decisions, e.g. for each detection unit or a combination of detection units.

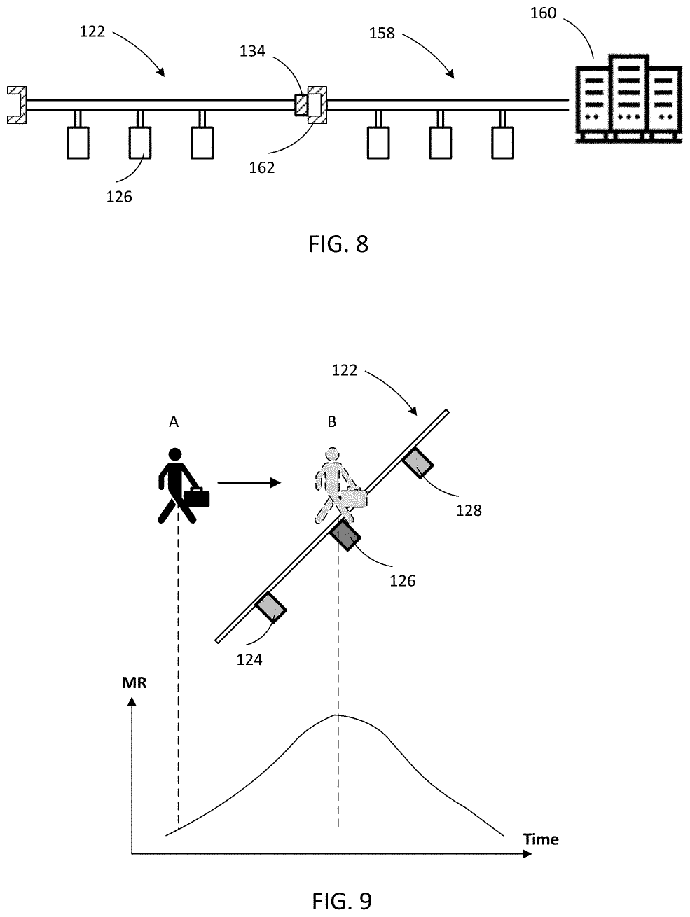

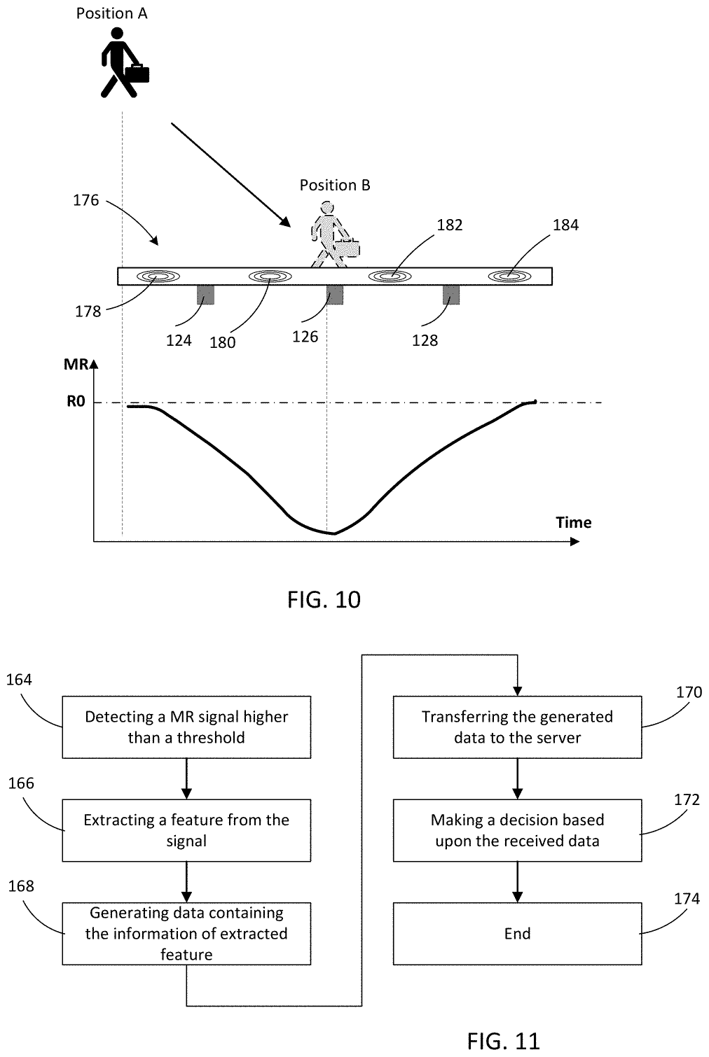

The detection unit can be implemented into many different forms, such as an active or passive detection, which will be discussed in the following with reference to FIG. 9 and FIG. 10. Referring to FIG. 9, detection unit 122 comprising detection nodes 124, 126 and 128 is deployed. Each detection node comprises an MR sensor. As a person carrying a metallic objects approaches the detection unit, for example, approaching detection node 126, the output of 126, which in a form of magnetoresistance MR, varies with the distance between the person and detection node 126. As shown in the lower figure, MR value from detection node 126 increases as the person approaches from the remote position wherein the MR value is minimum. MR increases as the person approaches detection node 126 and reaches the maximum when the person is right above to cross over detection node 126. MR decreases as the person walk away from detection node 126. The fact that MR changes with the distance between the person and detection unit changes can be simply explained as follows. The metallic object carried by the person can be magnetized when exposed to the magnetic field, such as the earth's magnetic field. It is similar to a permanent magnet as “seen” by a magnetic sensor. When the person carrying a metallic object is far away from the detection unit, the magnetic sensor in detection unit 126 detects the environment magnetic field, such as the earth's magnetic field at the location of detection unit 126. The metallic object, which behaves like a magnet has unmeasurable effect to detection node 126. When the distance between the person and detection node 126 is less than a threshold, which is primarily determined by the sensitivity of the magnetic sensor, the MR of the magnetic sensor starts to “detect” the metallic object carried by the person. Obviously, MR reaches the maximum value when the distance between the magnetic sensor and the metallic object is minimum.

In a passive implementation as illustrated in FIG. 9, the magnetic signal from the magnetic sensors of the detection nodes are generally small because the earth's magnetic field is small. This can be mitigated by providing an additional magnetic field, which is referred to as an active detection system, an example of which is illustrated in FIG. 10.

Referring to FIG. 10, multiple coils are installed in the detection unit (176), such as coils 178, 180, 182, and 184. The coils are provided to actively generate external magnetic field in the detection area cover by the detection unit. Multiple coils are provided to increase the strength of the external magnetic field. Multiple coils can also be benefit to a larger magnetic field far from the magnetic sensor and a smaller magnetic field in the vicinity of the magnetic sensor. Larger magnetic field far from the magnetic sensor benefits stronger magnetization of a metallic object; while a smaller magnetic field at the location of the magnetic sensor is advantageous for higher sensitivity of the magnetic sensor. For this reason, the number of coils and the spatial deployment of the coils are carefully calculated and arranged. The lower diagram in FIG. 10 illustrates a time dependent MR signal as a person carrying a metallic object approaches to and walk away from detection node 126 of detection unit 176.

When the person is at positon A far away from magnetic sensor of detection node 126, MR signal corresponds to the background magnetic field, such as the earth's magnetic field. As the person approaches to the magnetic sensor of detection node 126, MR decreases due to the demagnetization field from the metallic object carried by the person. The MR signal reaches the minimum value when the metallic object is right above the magnetic sensor of detection node 126. MR increases as the person walks away.

FIG. 11 is a diagram showing the steps executed in an exemplary detection process. Referring to FIG. 11, a magnetic sensor of a detection node detects a MR signal that is higher than a threshold at step 164. The threshold can be predetermined based primarily upon the sensitivity of the magnetic sensor of the detection node. Other factors can also be included in setting up the threshold, for example, a threshold MR value corresponding to a “buffer distance.” The MR signals, which can be in a form of a time-varying profile signal, is processed by a DPU (e.g. a MCU) that extract signature features from the time-varying magnetic signals (step 166). At step 168, a data package can be generated for transfer over the data-bus to the server. This step can be performed by a data adapter. The data package is transferred to a server at step 170. The server makes a decision based upon the received data at step 172. The process can step at step 174.

It will be appreciated by those of skilled in the art that a new and useful detection unit and a method thereof have been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof. In the claims, only elements denoted by the words “means for” are intended to be interpreted as means plus function claims under 35 U.S.C. §112, the sixth paragraph.

We claim:

1. A detection system, comprising:
a data connection capable of serving as a data bus;
a plurality of detection nodes connected to the wire, wherein each detection node comprises:
a magnetic sensor capable of detecting a magnetic field and outputting an MR signal; and
a data processing unit capable of extracting a signature feature signal from the MR signal; and
a server capable of making a decision based upon the signature feature.

2. The system of claim 1, wherein the data processing unit comprises a wavelet analysis algorithm.

3. The system of claim 1, further comprising:
an AI accelerator accompanying said server.

4. The system of claim 1, further comprising:
a server connected to the wire, wherein the server is capable of making a decision based upon the signature feature using an AI deep learning algorithm.

5. The system of claim 1, where the wire is connected to a male adaptor and a female adaptor to repeat in a space.

6. The system of claim 1, further comprising:
a network relay.

7. The system of claim 1, wherein the magnetic sensor comprises a GMR sensor.

8. The system of claim 1, wherein the magnetic sensor comprises an AMR sensor.

9. The system of claim 1, wherein the magnetic sensor comprises a TMR sensor.

10. The system of claim 1, further comprising:
a plurality of coils disposed along the length of a wire, wherein said wire is part of the data connection data connection.

9. The system of claim 1, wherein the wire is cover by a rigid tube, and the detection nodes are anchored in the rigid tube.

10. The system of claim 9, wherein the detection nodes are uniformly spaced along the length of the rigid tube.

11. A method of detecting a metallic object, comprising:
providing a detection node that comprises:
a wire serving as a data-bus;
a server connected to the wire;
a plurality of detection nodes connected to the wire, each of the detection node comprises:
a magnetic sensor;
a data processing unit;
and a data adaptor;
generating by an MR signal by a magnetic sensor, wherein the MR signal corresponds to the metallic object;
extracting a signature feature from the MR signal by the data processing unit;
transferring the signature feature by the data adaptor to the data bus; and
the server making a decision based upon the signature data;

12. The method of claim 11, wherein the signature feature is extracted by using a wavelet analysis algorithm.

13. The method of claim 11, wherein the server makes the decision by using an AL deep learning algorithm.
